(19) United States
(12) Patent Application Publication
(10) Pub. No.: US 2025/0280240 A1
(43) Pub. Date: Sep. 4, 2025

(54) SPEAKER

(71) Applicant: Merry Electronics(Shenzhen) Co., Ltd., ShenZhen (CN)

(72) Inventor: Tsung-Lung Chang, Taichung (TW)

(73) Assignee: Merry Electronics(Shenzhen) Co., Ltd., ShenZhen (CN)

(21) Appl. No.: 18/822,262

(22) Filed: Sep. 1, 2024

Related U.S. Application Data
(60) Provisional application No. 63/560,789, filed on Mar. 4, 2024.

(51) Int. Cl. H04R 9/02; H04R 9/04; H04R 9/06

(52) U.S. Cl. CPC H04R 9/025; H04R 9/046; H04R 9/06

(57) ABSTRACT

A speaker includes a frame, a magnetic circuit system, and a diaphragm structure. The magnetic circuit system is arranged in the frame. A central part of the diaphragm structure is located on a voice coil of the magnetic circuit system. A connecting part of the diaphragm structure surrounds an outer edge of the central part. A first end of the connecting part faces the voice coil, and a second end of the connecting part is provided with a protruding structure. A hanging edge of the diaphragm structure includes a first bending section and a second bending section connected to each other, and the second bending section is connected to the protruding structure. In a normal direction of a bottom surface of the frame, the protruding structure is higher than a connection between the first bending section and the second bending section.

### CROSS-REFERENCE TO RELATED APPLICATION

This application claims the priority benefits of U.S. provisional application Ser. No. 63/560,789, filed on Mar. 4, 2024. The entirety of the above-mentioned patent application is hereby incorporated by reference herein and made a part of this specification.

### BACKGROUND

### Technical Field

The disclosure relates to a speaker, and in particular to a speaker including a diaphragm.

### Description of Related Art

Generally speaking, speakers can use the movement of the voice coil under the action of electromagnetism to cause the diaphragm to vibrate and then emit sound. However, when the outer diameter of the diaphragm increases, the jib of the diaphragm may need to be lengthened. However, the above approach is not conducive to miniaturization. The reason is that in general, the longer the jib, the greater the slope of the jib required and the higher the structural height. Therefore, if the diameter increases and the jib is lengthened, since the lengthening of the jib will produce split modes, it is possible to increase the diaphragm structure height to improve the diaphragm strength to reduce mode splits. However, if the way of increasing diaphragm height is used, it is not conducive to thinning. In addition, when the diaphragm vibrates, the lengthened jib of the diaphragm may cause irregular vibration behavior and prone to segmented vibration, thereby affecting the sound pressure output. Or, when the outer diameter of the diaphragm increases, the outer diameter of the voice coil also increases, but the above approach greatly increases the cost of the magnetic circuit structure.

### SUMMARY

The disclosure provides a speaker that effectively suppresses a split vibration of a diaphragm and is conducive to miniaturization.

The speaker of the disclosure includes a frame, a magnetic circuit system, and a diaphragm structure. The frame has a bottom surface. The magnetic circuit system is disposed in the frame. The magnetic circuit system includes a voice coil, and the bottom surface corresponds to the outside of the voice coil. The diaphragm structure is disposed within the frame. The diaphragm structure includes a central part, a connecting part, and a hanging edge. The center part is located on the voice coil. The connecting part surrounds an outer edge of the central part. The connecting part has a first end and a second end opposite to each other. The first end faces the voice coil, and the second end is provided with a protruding structure. The connecting part is located between the central part and the hanging edge. The hanging edge includes a first bending section and a second bending section connected to each other. The second bending section is connected to the protruding structure. In a normal direction of the bottom surface, the protruding structure is higher than a connection between the first bending section and the second bending section.

In an embodiment of the disclosure, in the normal direction of the bottom surface, a distance between the first end and the bottom surface is smaller than a distance between a vertex of the protruding structure and the bottom surface.

In an embodiment of the disclosure, in the normal direction of the bottom surface, the distance between the connection and the bottom surface is greater than the distance between the first end and the bottom surface.

In an embodiment of the disclosure, an orthographic projection of the protruding structure on the bottom surface overlaps an orthographic projection of the second bending section on the bottom surface.

In an embodiment of the disclosure, the protruding structure is attached to a lower surface of the second bending section, and the lower surface faces the bottom surface.

In an embodiment of the disclosure, the hanging edge further includes a straight line section. The straight line section is parallel to the bottom surface. The first bending section is located between the straight line section and the second bending section. The straight line section is connected between the frame and the first bending section.

In an embodiment of the disclosure, the first bending section protrudes in a direction away from the bottom surface.

In an embodiment of the disclosure, the second bending section protrudes in a direction away from the bottom surface.

In an embodiment of the disclosure, the protruding structure protrudes in a direction away from the bottom surface.

In an embodiment of the disclosure, the magnetic circuit system further includes a magnet, and the magnet is arranged inside the voice coil.

Based on the above, in the speaker of the disclosure, the diaphragm structure includes the central part, the connecting part, and the hanging edge, and the connecting part is located between the central part and the hanging edge. One end of the connecting part connected to the hanging edge is provided with the protruding structure. The hanging edge includes the first bending section and the second bending section. The protruding structure is higher than the connection between the first bending section and the second bending section, so that the connecting part may have a higher inclination angle to provide high mechanical strength and suppress the split vibration of the diaphragm structure.

To make the aforementioned more comprehensible, several embodiments accompanied with drawings are described in detail as follows.

### BRIEF DESCRIPTION OF THE DRAWINGS

FIG. 1 is a schematic three-dimensional view of a speaker according to an embodiment of the disclosure.

FIG. 2 is a schematic cross-sectional view of the speaker of FIG. 1.

FIG. 3 is a schematic cross-sectional view of the diaphragm structure of FIG. 2.

FIG. 4 is a partially enlarged schematic diagram of a diaphragm structure of FIG. 3.

FIG. 5 is a schematic side view of the speaker of FIG. 2.

FIG. 6 is a partial enlarged schematic diagram of the speaker of FIG. 5.

FIG. 7 is a schematic diagram comparing a frequency response of a speaker according to an embodiment of the disclosure and a conventional diaphragm.

FIGS. 8A and 8B are schematic diagrams comparing the vibration displacement measurement of the diaphragm structure and the conventional diaphragm according to an embodiment of the disclosure.

### DESCRIPTION OF THE EMBODIMENTS

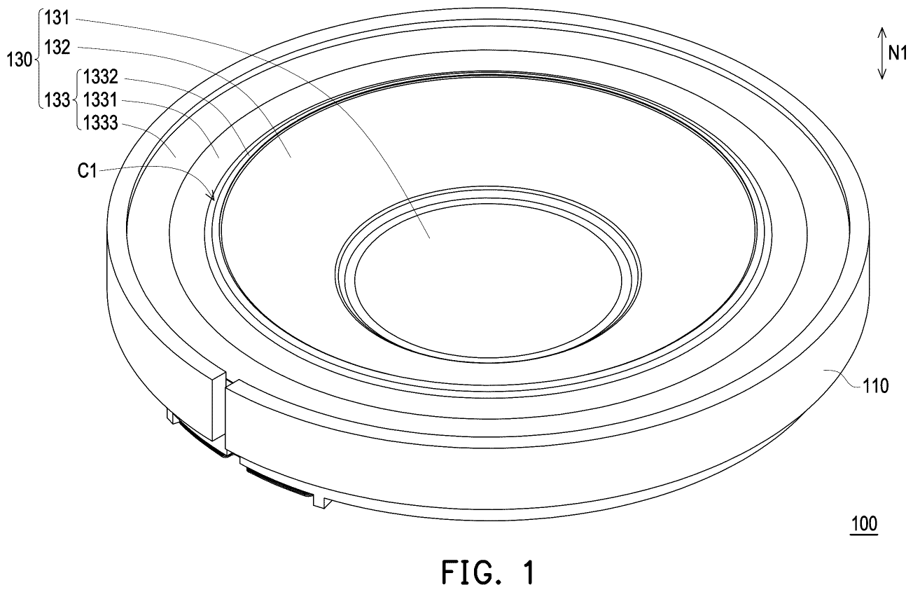

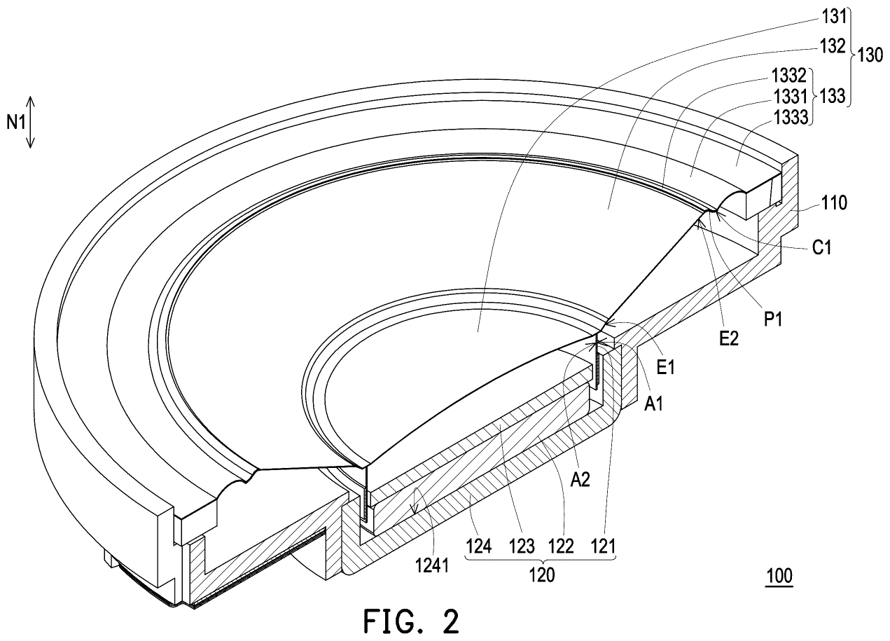

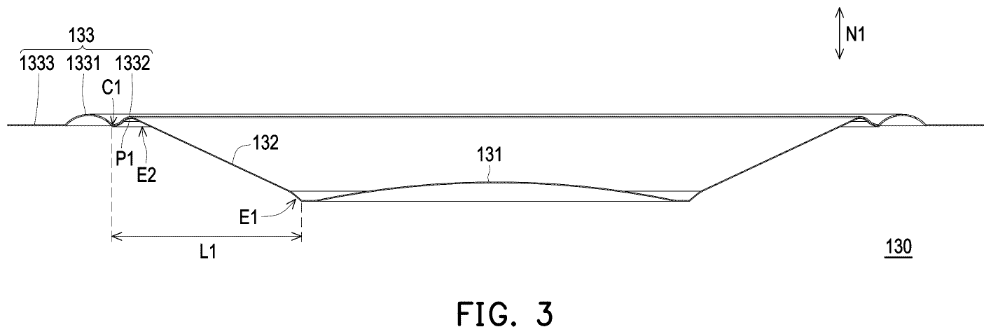

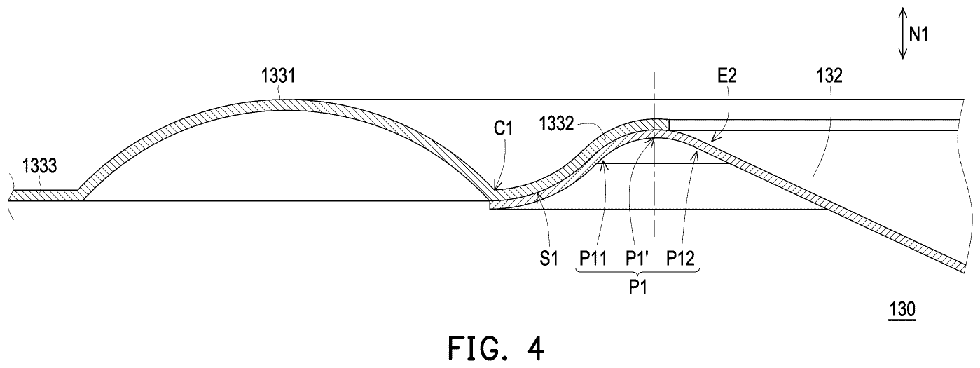

FIG. 1 is a schematic three-dimensional view of a speaker according to an embodiment of the disclosure. FIG. 2 is a schematic cross-sectional view of the speaker of FIG. 1. FIG. 3 is a schematic cross-sectional view of the diaphragm structure of FIG. 2. FIG. 4 is a partially enlarged schematic diagram of a diaphragm structure of FIG. 3. Referring to FIGS. 1 to 4, a speaker 100 of this embodiment includes a frame 110, a magnetic circuit system 120, and a diaphragm structure 130.

In this embodiment, the frame 110 has a bottom surface 1241. The magnetic circuit system 120 is disposed in the frame 110. The magnetic circuit system 120 includes a voice coil 121, a magnet 122, a pole plate 123, and a bottom yoke 124. Here, a side of the bottom yoke 124 facing the magnet 122 is defined as the bottom surface 1241, and the bottom surface 1241 may be regarded as a lowest point in an internal space of the frame, but is not limited thereto. The voice coil 121 has an outer side A1 and an inner side A2 opposite to each other. The magnet 122 is arranged on the inner side A2 of the voice coil 121 and is surrounded by the voice coil 121. Under an action of a magnetic field of the magnet 122 and the pole plate 123, the voice coil 121 is driven to move, and the diaphragm structure 130 connected to the voice coil 121 also moves accordingly, driving the air adjacent to the diaphragm structure 130 to vibrate and sound, but is not limited thereto.

In this embodiment, the diaphragm structure 130 is disposed within the frame 110. The diaphragm structure 130 includes a central part 131, a connecting part 132, and a hanging edge 133. The connecting part 132 surrounds an outer edge of the central part 131 and is located between the central part 131 and the hanging edge 133. The central part 131 is a dome and is located on the voice coil 121. The connecting part 132 has an first end E1 and a second end E2 opposite to each other. The first end E1 of the connecting part 132 faces the voice coil 121.

In this embodiment, the central part 131 and the connecting part 132 are integrally formed thin film sheets and are made of hard materials, such as metal, carbon fiber, polyurethane (PU), or paper, etc., but the disclosure is not limited thereto. In this embodiment, the hanging edge 133 is annular and made of soft material, such as rubber or polyurethane (PU), but the disclosure is not limited thereto. Here, hardness and softness are relative concepts. As long as a rigidity of the central part 131 and the connecting part 132 is greater than a rigidity of the hanging edge 133, it is considered to be within the scope of the disclosure.

Generally speaking, a conventional jib is usually a straight line or curve with a continuous slope without reversal. However, when the outer diameter of the diaphragm increases, under the condition that the outer diameter of the voice coil is the same, the cantilever needs to be lengthened, which is prone to modal splitting. The speaker of the disclosure can solve the above problems.

In this embodiment, the second end E2 of the connecting part 132 is provided with a protruding structure P1, and the protruding structure P1 protrudes in a direction away from the bottom surface 1241. Specifically, the connecting part 132 and the protruding structure P1 are integrally formed thin film sheets, and the connecting part 132 and the protruding structure P1 are defined as a jib area L1 (FIG. 3).

In this embodiment, the hanging edge 133 includes a first bending section 1331 and a second bending section 1332 connected to each other, and the second bending section 1332 is connected to the protruding structure P1.

In this embodiment, the hanging edge 133 further includes a straight line section 1333. The straight line section 1333 is parallel to the bottom surface 1241. The first bending section 1331 is located between the straight line section 1333 and the second bending section 1332. The straight line section 1333 is connected to the frame 110 and the first bending section 1331. In an embodiment, a load ring is provided below the straight line section 1333 to support the hanging edge 133, but is not limited thereto.

In this embodiment, the connecting part 132 is inclined to the bottom surface 1241 and is not parallel to the bottom surface 1241. In a normal direction N1 of the bottom surface 1241, the protruding structure P1 is higher than a connection C1 between the first bending section 1331 and the second bending section 1332. In this way, the connecting part 132 may have a straight line or a curve with a relatively high inclination angle to provide high mechanical strength and suppress split vibration of the diaphragm structure 130.

In this embodiment, the first bending section 1331 protrudes in a direction away from the bottom surface 1241, but is not limited thereto. In other embodiments, the first bending section 1331 may also be a concave structure, as long as the protruding structure P1 is higher than the connection C1 between the first bending section 1331 and the second bending section 1332, so that the connecting part 132 has a higher inclination angle, it is considered to be within the scope of the disclosure, and is not limited by the disclosure.

In an embodiment, the end of the protruding structure P1 extends to the connection C1, but the disclosure is not limited thereto.

In an embodiment, the end of the second bending section 1332 extends to a vertex P1′ of the protruding structure P1, but the disclosure is not limited thereto. It should be noted that the second bending section 1332 is configured to bond to the protruding structure P1, and the length of the second bending section 1332 may be appropriately adjusted depending on the size of a bonding area, which is not limited by the disclosure.

Referring to FIG. 4, in an embodiment, a slope of the vertex P1′ of the protruding structure P1 is 0. With the vertex P1′ as a boundary, the left and right sides of the protruding structure P1 are a first side P11 and a second side P12, respectively. The slope of the first side P11 is greater than 0. The slope of the second side P12 is less than 0. An absolute value of the slope of the first side P11 is equal to the absolute value of the slope of the second side P12, but is not limited thereto.

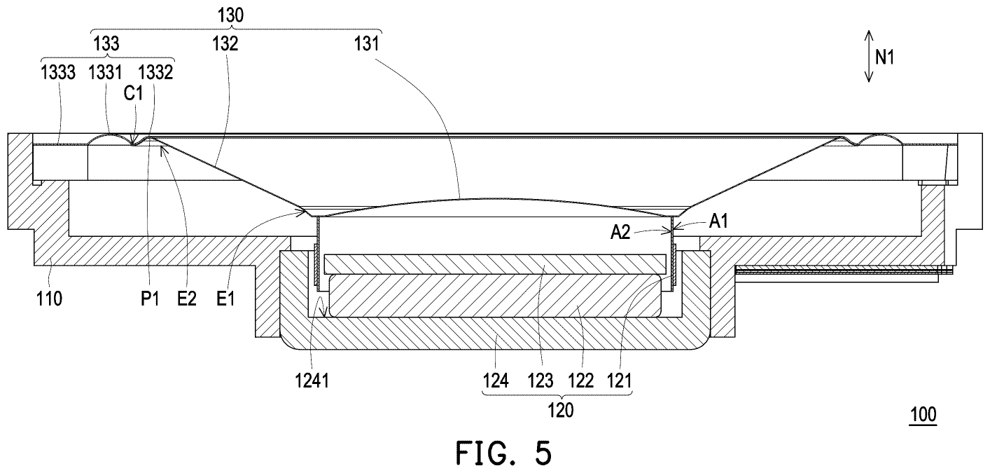

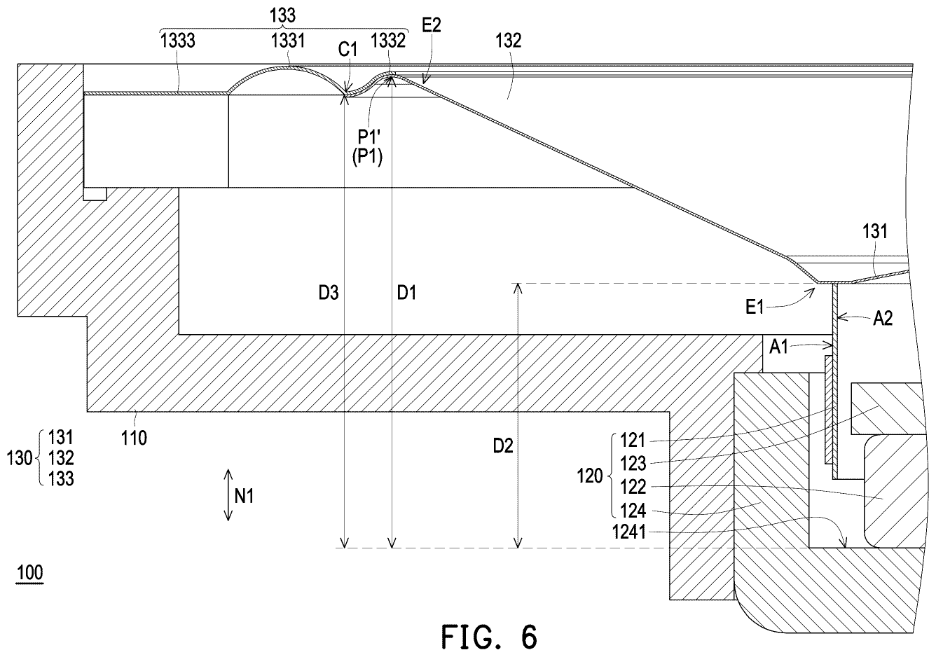

FIG. 5 is a schematic side view of the speaker of FIG. 2. FIG. 6 is a partial enlarged schematic diagram of the speaker of FIG. 5. Referring to FIGS. 5 and 6, in this embodiment, there is a plane between the first end E1 of the connecting part 132 and the central part 131 for fixing the voice coil 121, but it is not limited thereto.

Referring to FIG. 6, in this embodiment, in the normal direction N1 of the bottom surface 1241, a distance D2 between the first end E1 and the bottom surface 1241 is less than a distance D1 between the vertex P1′ of the protruding structure P1 and the bottom surface 1241. A distance D3 between the connection C1 and the bottom surface 1241 is greater than the distance D2 between the first end E1 and the bottom surface 1241. The distance D3 between the connection C1 and the bottom surface 1241 is less than the distance DI between the vertex P1′ of the protruding structure P1 and the bottom surface 1241.

Referring to FIGS. 4 and 6, in this embodiment, the second bending section 1332 protrudes in a direction away from the bottom surface 1241 to bond to the protruding structure P1. In an embodiment, an orthographic projection of the protruding structure P1 on the bottom surface 1241 overlaps with an orthographic projection of the second bending section 1332 on the bottom surface 1241. For example, the protruding structure P1 is attached to a lower surface S1 of the second bending section 1332, and the lower surface S1 faces the bottom surface 1241, but is not limited thereto.

Under the above configuration, the first side P11 of the vertex P1′ of the protruding structure P1 is connected to the hanging edge 133 with a smooth curve, providing a gentle intensity change. The diaphragm structure 130 may be controlled by the protruding structure P1 to meet the mechanical strength requirements, and may provide higher mechanical strength than the conventional technology under the same size of the diaphragm structure 130. In addition, the protruding structure P1 can provide a larger effective vibration area in a limited height space, improve a sound pressure level (SPL) performance, and facilitate thinning.

In an embodiment, by adjusting the position of the protruding structure P1, the lengths of the left and right sides of the protruding structure P1 may be controlled, and the jib area L1 (FIG. 3) and the position of the protruding structure P1 may be changed to form a node to destroy the vibration energy transmission and avoids mode splits.

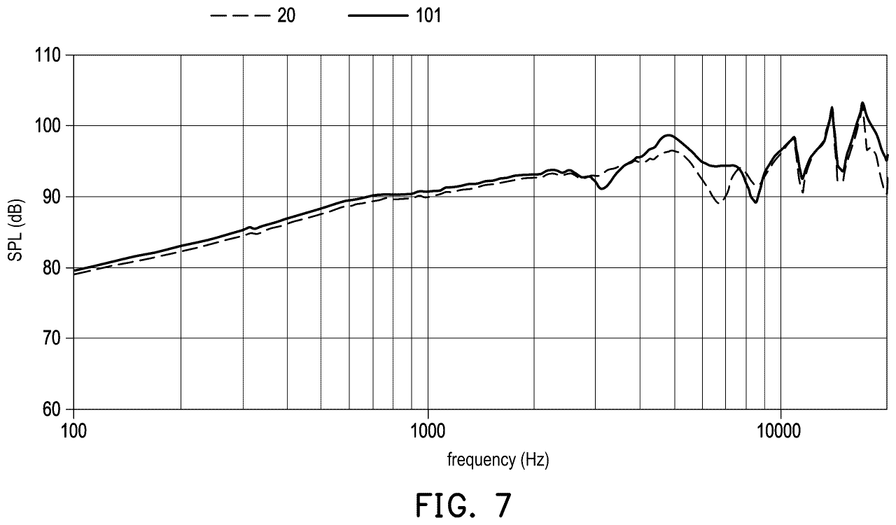

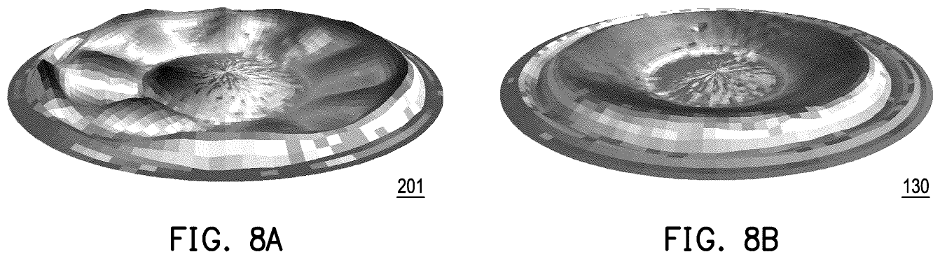

FIG. 7 is a schematic diagram comparing a frequency response of a speaker according to an embodiment of the disclosure and a conventional diaphragm. FIGS. 8A and 8B are schematic diagrams comparing the vibration displacement measurement of the diaphragm structure and the conventional diaphragm according to an embodiment of the disclosure.

Referring to FIG. 7 first, a line section 20 represents the frequency response of the conventional diaphragm, and a line section 101 represents the frequency response of the diaphragm structure 130 of this embodiment. It may be seen from experiments that under the same diaphragm outer diameter condition, the diaphragm structure 130 can suppress the generation of split modes in the jib area L1 (FIG. 3), which facilitates the frequency response performance of mid-to-high frequencies. Here, the mid-to-high frequencies are, for example, 4 KHz to 8 KHz, but are not limited thereto.

Referring to FIG. 8A and FIG. 8B, in an embodiment, a laser is used to sweep the vibration displacement of the diaphragm to measure a frequency point of 5 KHz. FIG. 8A shows the experimental results of a conventional diaphragm 201. FIG. 8B shows the experimental results of the diaphragm structure 130 of this embodiment. It may be seen that in the measurement results of the conventional structure, the jib of the diaphragm 201 has split modes. According to the measurement results of the diaphragm structure 130 of this embodiment, the split mode has been improved and no split mode has occurred.

To sum up, in the speaker of the disclosure, the hanging edge includes the first bending section and the second bending section, and the jib area is provided with the protruding structure. The protruding structure is higher than the connection between the first bending section and the second bending section, so that the connecting part may have a higher inclination angle to provide high mechanical strength and suppress the split vibration of the diaphragm structure. Furthermore, the protruding structure can provide a larger effective vibration area in a limited height space, improve the sound pressure level performance, and facilitate thinning. In addition, by adjusting the position of the protruding structure, the length of the left and right sides of the protruding structure can be controlled, and the jib area and the position of the protruding structure can be changed to form nodes to destroy vibration energy transmission and avoid mode splits.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A speaker, comprising:
a frame, having a bottom surface;
a magnetic circuit system, disposed in the frame, wherein the magnetic circuit system comprises a voice coil; and
a diaphragm structure, disposed within the frame and comprising:
a central part, located on the voice coil;
a connecting part, surrounding an outer edge of the central part, wherein the connecting part has an first end and a second end opposite to each other, the first end faces the voice coil, and the second end is provided with a protruding structure; and
a hanging edge, wherein the connecting part is located between the central part and the hanging edge, the hanging edge comprises a first bending section and a second bending section connected to each other, the second bending section is connected to the protruding structure, wherein
in a normal direction of the bottom surface, the protruding structure is higher than a connection between the first bending section and the second bending section.

2. The speaker according to claim 1, wherein in the normal direction of the bottom surface, a distance between the first end and the bottom surface is less than a distance between a vertex of the protruding structure and the bottom surface.

3. The speaker according to claim 1, wherein in the normal direction of the bottom surface, a distance between the connection and the bottom surface is greater than the distance between the first end and the bottom surface.

4. The speaker according to claim 1, wherein an orthographic projection of the protruding structure to the bottom surface overlaps an orthographic projection of the second bending section to the bottom surface.

5. The speaker according to claim 1, wherein the protruding structure is attached to a lower surface of the second bending section, and the lower surface faces the bottom surface.

6. The speaker according to claim 1, wherein the hanging edge further comprises a straight line section, the straight line section is parallel to the bottom surface, the first bending section is located between the straight line section and the second bending section, and the straight line section connects between the frame and the first bending section.

7. The speaker according to claim 1, wherein the first bending section protrudes in a direction away from the bottom surface.

8. The speaker according to claim 1, wherein the second bending section protrudes in a direction away from the bottom surface.

9. The speaker according to claim 1, wherein the protruding structure protrudes in a direction away from the bottom surface.

10. The speaker according to claim 1, wherein the magnetic circuit system further comprises a magnet, and the magnet is arranged inside the voice coil.
